(19) United States
(12) Patent Application Publication
(10) Pub. No.: US 2008/0068464 A1
(43) Pub. Date: Mar. 20, 2008

(54) System for delivering images, program for delivering images, and method for delivering images

(75) Inventors: Sachiko Kitagawa, Kawasaki (JP); Osafumi Nakayama, Kawasaki (JP); Morito Shiohara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/648,535

(22) Filed: Jan. 3, 2007

(30) Foreign Application Priority Data
Sep. 14, 2006 (JP) 2006-249252

(51) Int. Cl. H04N 7/18

(52) U.S. Cl. 348/159

(57) ABSTRACT

The present invention provides a system for delivering images, a program for delivering images, and a method for delivering images, which can deliver images according to the monitoring state for the images. There is provided a system for delivering images to at least one monitor, which includes an image receiving unit that takes in at least one image to be displayed on the monitors, a state receiving unit that takes in the monitoring state of the respective monitors, and a delivery unit that selects destination monitors from among the monitors based on the monitoring state taken in by the state receiving unit, and selects delivery images which are images to be delivered to the respective destination monitors from among images taken in by the image receiving unit, and delivers the delivery images to the corresponding destination monitors.

### BACKGROUND OF THE INVENTION

1. Field of the Invention

The present invention relates to a system for delivering images, a program for delivering images, and a method for delivering images, which are adapted to deliver images to be displayed on monitors.

2. Description of the Related Art

Conventionally, in order to promptly find out abnormal circumstances, there has been employed a work in which a person (observer) monitors images displayed on a monitoring camera. However, in case a single observer monitors images alone, there may be raised a drawback that images are not seen and monitored due to the temporary absence, looking aside, lack of concentration, etc., of the observer.

In order to solve the problem, there have been employed two methods.

The first method is a method that can make an observer concentrate on the monitoring work even if the observer monitors images alone. Under this method, it is checked whether or not an observer performs the monitoring work normally at regular intervals, and in case the monitoring work is not normally performed, the observer is prompted to resume the monitoring work normally. Specifically, there is disclosed Patent Document 1 (Jpn. Pat. Appln. Laid-Open Publication No. 5-81581), in which an observer is prompted to input data at preset time points, and it is judged whether or not the observer performs the monitoring work normally by checking the presence of data inputting and the normality of input data. In case it is determined that the monitoring work is not normally performed, an alarm is given so as to prompt the observer to resume the monitoring work.

The second method is a method that prepares standby observers. Under this method, a plurality of observers perform the monitoring work in a single room, and images which are not monitored due to the temporary absence of an observer are monitored by another observer. This method is called a centralized monitoring system, which is generally employed.

In employing the first method, an alarm is given so as to prompt an observer to resume the monitoring work. On the other hand, in case the situation in which the monitoring work cannot be resumed is continued, a situation in which no one monitors images occurs, and there is undesirably raised failure in the monitoring work. Accordingly, primarily, it is impossible for a single person to perform the monitoring work by employing the first method, and it is necessary to employ the second method under which a plurality of observers are prepared to back up the monitoring work.

However, there is raised a problem, to be described hereinafter, concerning the optimum observer allocation in the second method. According to “Guidelines for the industrial health controls of VDT (Visual Display Terminals) operations (operations to perform the monitoring work, etc. using a VDT work apparatus)” which is published by Ministry of Health, Labour and Welfare on Apr. 5, 2002, it is specified that the following work management should be performed in performing a VDT operation.

One continuous operation time:
Must not exceed one hour

Operation downtime:
10 to 15 minutes before subsequent continuous operation

Furthermore, according to the Labor Standards Law, chapter 4, article 34, it is stipulated that “an employer shall provide rest periods during working hours of at least 45 minutes in the event that working hours exceed six hours and of at least one hour in the event that working hours exceed eight hours”.

Based on the guidelines and the law, an observer allocation without waste is tentatively calculated. In case the four-shift of six hours is employed, for images corresponding to six observers, seven observers have to alternately monitor the images. On the other hand, in case the three-shift system of eight hours is employed, which is the general rotation for 24-hour monitoring system, for images corresponding to 72 observers, 91 observers have to alternately monitor the images.

Hereinafter, in case the expectation for monitoring cameras is enhanced, and the number of monitoring cameras is increased, in which case the necessity of increasing the number of observers is heightened, it can be considered that the demand of performing the monitoring work in a small-sized space such as a room for security guards of respective buildings and a home of an individual is enhanced by taking advantage of the merit that an existing space can be used. Accordingly, even if smaller number of observers are allocated in one place as compared with the conventional case, it is required that the monitoring work needs to performed effectively. However, in case an attempt is made to make the number of observers in one place smaller than that in the conventional optimum observer allocation, there are undesirably raised time periods in which observers become redundant, which is not effective.

For example, it is assumed that there are three monitoring rooms in each of which images corresponding to two observers are monitored by three observers, and the four-shift of six hours is employed. It can be seen that there are images corresponding to six observers and there are nine observers in all. However, since the optimum number of observers is seven as described above in case of making a calculation by paying notice to only the number of images, it is found that two observers become redundant. In this case, it is desirable to unify the three monitoring rooms into one place to perform the optimum observer allocation, which is difficult due to physical and geographical problems.

### SUMMARY OF THE INVENTION

It is therefore an object of the present invention to overcome the above-mentioned drawbacks by providing a system for delivering images, a program for delivering images, and a method for delivering images, which can deliver images according to the monitoring state for the images.

According to the present invention, there is provided a system for delivering images to at least one monitor, the system including: an image receiving unit that takes in at least one image to be displayed on the monitor; a state receiving unit that takes in the monitoring state of the respective monitors; and a delivery unit that selects destination monitors from among the monitors based on the monitoring state taken in by the state receiving unit, and selects delivery images which are imaged to be delivered to the respective destination monitors from among images taken in by the image receiving unit, and delivers the delivery images to the corresponding destination monitors.

According to the system for delivering images, the delivery unit sets monitors whose monitoring state is normal-to-normal monitors, and sets the normal monitors to the destination monitors.

According to the system for delivering images, the delivery unit distributes images taken in by the image receiving unit to the destination monitors, and updates the distribution result as delivery images for the respective destination monitors.

According to the system for delivering images, the image receiving unit further takes in pickup source identifiers indicative of pickup sources of taken in images, the system further includes: a standard information receiving unit that, with respect to standard images which are images to be displayed on the monitors, takes in pickup source identifiers of the standard images for the respective monitors set up in advance, and the delivery unit sets monitors other than the normal monitors to abnormal monitors, and, based on pickup source identifiers taken in by the image receiving unit and pickup source identifiers taken in by the standard information receiving unit, sets standard images corresponding to the normal monitors to delivery images to the normal monitors, and delivers standard images corresponding to the abnormal monitors to the normal monitors.

According to the system for delivering images, in case a plurality of delivery images are selected for a specific destination monitor, the delivery unit combines the plural delivery images to set thus combined image to a delivery image, and delivers the delivery image to the specific destination monitor.

According to the system for delivering images, in case a plurality of delivery images are selected for a specific destination monitor, the delivery unit delivers the plural delivery images and delivery information which is information related to the delivery images to the specific destination monitor, the system further including: display control units each of which receives a plurality of delivery images and delivery information delivered from the delivery unit, and combines the plural delivery images based on the delivery information to set thus combined image to a single display image, and makes the specific destination monitor display the display image.

According to the system for delivering images, the delivery information includes the number of the plural delivery images to be delivered to the specific destination monitor.

According to the system for delivering images, with respect to the plural delivery images to be delivered to the specific destination monitor, the delivery information includes disposition information at the time of displaying the delivery images.

According to the system for delivering images, the system further includes: state detection units which are arranged for the respective monitors, each of which detects the monitoring state of the monitor to output thus detected monitoring state to the state receiving unit.

According to the system for delivering images, the state detection units output inputs from the observers for the monitors to the state receiving unit as the monitoring state.

According to the system for delivering images, the state detection units detect the environment of the monitors to output the detection result, and the system further includes: state judgment units each of which judges whether or not the observer normally observes the monitor based on the detection result by the state detection unit, and outputs the judgment result to the state receiving unit as the monitoring state.

According to the system for delivering images, the state detection units pick up images, and are so arranged as to pick up observers who observe the monitors to send the picking up result to the state judgment units as the detection result.

According to the system for delivering images, each of the state judgment units extracts, from the picking up result by the state detection unit, at least any one of the presence of the observer, direction of the face of the observer, time period during which eyes of the observer are closed, and determines that the monitoring state is normal in case the extraction result fulfills a predetermined condition.

According to the system for delivering images, the system further includes: image pickup units which pick up subjects to be monitored, and output thus picked up images to the image receiving unit.

According to the system for delivering images, the system further includes: notification input units which are arranged for the respective monitors, and receive input of notification by the observers for the monitors.

According to the system for delivering images, the delivery unit selects the destination monitors and the delivery images every time the monitoring state is changed.

According to the present invention, there is also provided a computer-readable recording medium which stores a program for delivering images which makes a computer deliver images to be displayed on monitors, the program including: an image receiving step that takes in at least one image to be displayed on the monitors; a state receiving step that takes in the monitoring state of the respective monitors; and a delivery step that selects destination monitors from among the monitors based on the monitoring state taken in by the state receiving step, and selects delivery images which are images to be delivered to the respective destination monitors from among images taken in by the image receiving step, and delivers the delivery images to the corresponding destination monitors.

According to the computer-readable recording medium which stores the program for delivering images, the delivery step sets monitors whose monitoring state is normal-to-normal monitors, and sets the normal monitors to the destination monitors.

According to the computer-readable recording medium which stores the program for delivering images, the delivery step distributes images taken in by the image receiving step to the destination monitors, and sets the distribution result to delivery images for the respective destination monitors.

According to the present invention, there is also provided a method for delivering images to be displayed on monitors, the method including: an image receiving step that takes in at least one image to be displayed on the monitors; a state receiving step that takes in the monitoring state of the respective monitors; and a delivery step that selects destination monitors from among the monitors based on the monitoring state taken in by the state receiving step, and selects delivery images which are images to be delivered to the respective destination monitors from among images taken in by the image receiving step, and delivers the delivery images to the corresponding destination monitors.

According to the present invention, it becomes possible to deliver images according to the monitoring state by monitors.

### BRIEF DESCRIPTION OF THE DRAWINGS

FIG. 1 shows a block diagram indicative of one example of the configuration of the system for delivering images according to the first embodiment;

FIG. 2 shows a table indicative of one example of a monitoring state list according to the first embodiment;

FIG. 3 shows a table indicative of one example of a delivery image list according to the first embodiment;

FIG. 4 shows a flowchart indicative of one example of the operation of a first delivery processing according to the first embodiment;

FIG. 5 shows a flowchart indicative of one example of the operation of a second delivery processing according to the first embodiment;

FIG. 6 shows a flowchart indicative of one example of the operation of a first distribution processing according to the first embodiment;

FIG. 7 shows a table indicative of one example of a standard monitoring image list according to the first embodiment;

FIG. 8 shows a flowchart indicative of one example of the operation of a second distribution processing according to the first embodiment;

FIG. 9 shows a specific example of the operation of the system for delivering images according to the first embodiment;

FIG. 10 shows a block diagram indicative of one example of the configuration of the system for delivering images according to the second embodiment;

FIG. 11 shows a flowchart indicative of one example of the operation of the monitoring state judgment processing according to the second embodiment; and

FIG. 12 shows a block diagram indicative of one example of the configuration of the system for delivering images according to the third embodiment.

### DETAILED DESCRIPTION OF THE PREFERRED EMBODIMENTS

The preferred embodiments according to the present invention will further be described below with reference to the accompanying drawings.

### First Embodiment

In this embodiment, a system for delivering images will be explained, in which data for suspending and resuming the monitoring work is input by observers and the image combining processing is performed at the display side.

Firstly, the configuration of the system for delivering images according to the first embodiment will be explained.

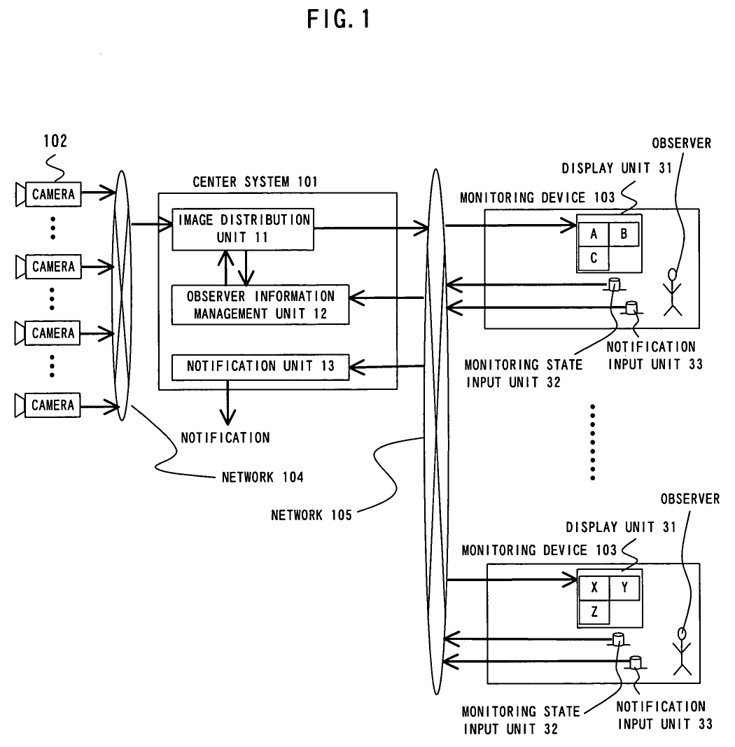

FIG. 1 shows a block diagram indicative of one example of the configuration of the system for delivering images according to the first embodiment. The system for delivering images includes a center system 101, a plurality of cameras 102, and a plurality of monitoring devices 103. The center system 101 and the plural cameras 102 are connected by a network 104. The center system 101 and the plural monitoring devices 103 are connected by a network 105. The center system 101 includes an image distribution unit 11, an observer information management unit 12, and a notification unit 13. Each of the monitoring devices 103 includes a display unit 31, a monitoring state input unit 32, and a notification input unit 33. The network 104 and the network 105 may be the same network.

Next, the operation of the system for delivering images according to the embodiment will be explained.

The respective plural cameras 102 send picked up images to the image distribution unit 11. To each of the images sent from the cameras 102, an image number indicative of one of the cameras 102 that picked up the image is appended.

For example, the monitoring state input unit 32 and the notification input unit 33 are buttons. When an observer suspends the monitoring work at the time of starting the intermission etc., the observer presses the button of the monitoring state input unit 32. Furthermore, when an observer resumes the monitoring work at the time of ending the intermission etc., the observer presses the button of the monitoring state input unit 32. When this button is pressed, the monitoring state input unit 32 sends state information that indicates that the monitoring state of the observer is changed to the observer information management unit 12. Moreover, in case it is necessary to send a notification to the job site or to security guards in emergency situations, an observer presses the button of the notification input unit 33. When this button is pressed, the notification input unit 33 sends notification information that indicates that sending a notification is necessary to the notification unit 13.

On the other hand, the monitoring state input unit 32 and the notification input unit 33 may be user interfaces displayed on the display unit 31.

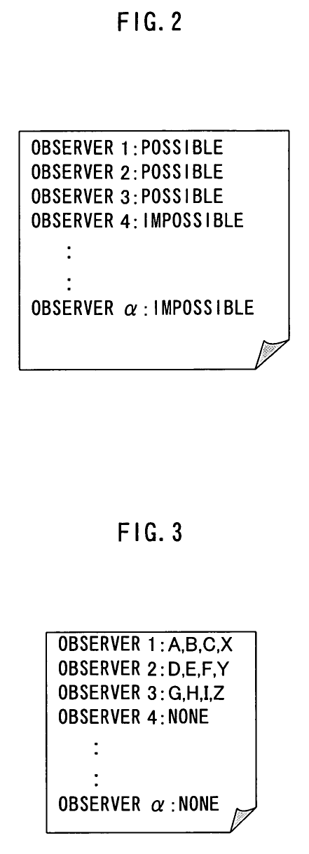

The observer information management unit 12 retains a monitoring state list and a delivery image list. FIG. 2 shows a table indicative of one example of the monitoring state list according to the embodiment. The monitoring state list retains values of “possible” (monitoring is possible) or “impossible” (monitoring is impossible) as the monitoring state for respective observers, which are supplied to the image distribution unit 11. Values of the “possible” and “impossible” in the monitoring state list are switched every time state information from the corresponding monitoring state input unit 32 is received (every time the button of the monitoring state input unit 32 is pressed). FIG. 3 shows a table indicative of one example of the delivery image list according to the embodiment. The delivery image list retains image numbers of delivery images which are images to be delivered for respective observers, which are updated by the image distribution unit 11.

The notification unit 13 that receives notification information from the notification input unit 33 sends a notification to the job site or to security guards.

Next, the operation of the delivery processing by the image distribution unit 11 will be explained. As the delivery processing, there are a first delivery processing in which the processing of combining a plurality of images to be displayed on the display unit 31 is performed by the monitoring device 103, and a second delivery processing in which this image combining processing is performed by the center system 101.

Firstly, the first delivery processing will be explained.

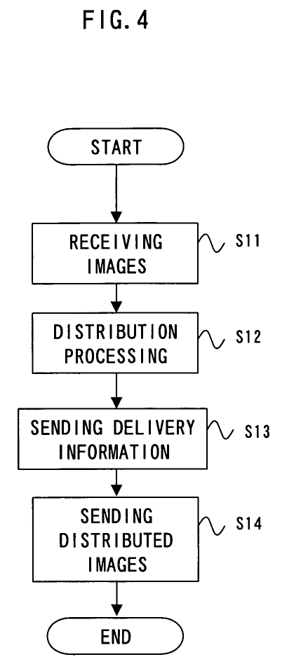

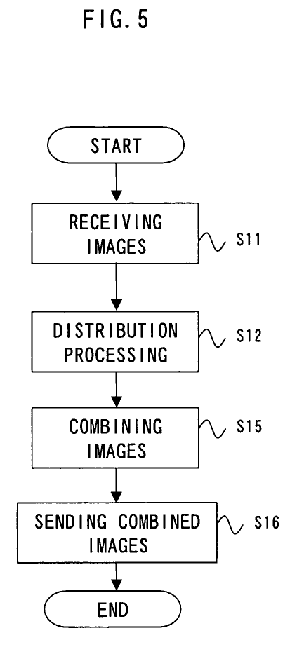

FIG. 4 shows a flowchart indicative of one example of the operation of the first delivery processing according to the embodiment. Firstly, the image distribution unit 11 receives images from the cameras 102 (S11). Each of thus received images has appended thereto an image number corresponding to one of the cameras 102. Furthermore, the number of received images is set to the number of images to be monitored. Next, the image distribution unit 11 performs the distribution processing of distributing images to observers who can perform the monitoring work based on the monitoring state list in the observer information management unit 12, and sends the result to the observer information management unit 12 as the delivery image list (S12). Next, the image distribution unit 11 sends delivery information including the number of images to be delivered to the display units 31 for the respective observers (S13), and sends distributed images thereto (S14), ending the flow. Afterward, this flow is repeated.

The display unit 31 that receives the delivery information and images from the image distribution unit 11 disposes the images based on the number of images in the delivery information to display the images. At this time, the display unit 31 determines the optimum image display size and disposition in accordance with the number of images to dispose the images. For example, in case of disposing the images in the form of a matrix, the delivery information includes image numbers, matrix size, and component numbers in the matrix. The image distribution unit 11 may determine the disposition of the images, and sends the result to the display unit 31 as the delivery information to make the display unit 31 dispose the images in accordance with the delivery information.

Next, the second delivery processing will be explained.

FIG. 5 shows a flowchart indicative of one example of the operation of the second delivery processing according to the embodiment. In this drawing, processing similar to that in FIG. 4 is indicated with the same step number, and detailed explanation of which will be omitted. Firstly, processing S11 and processing S12 are similar to those of the first delivery processing. Next, the image distribution unit 11 combines images to be delivered for respective delivery destinations to generate combined images (S15), and sends the combined images to the respective monitoring devices 103 (S16), ending the flow. Afterward, this flow is repeated.

The display units 31 which receive the combined images from the image distribution unit 11 display the combined images.

In this embodiment, the image distribution unit 11 repeats the distribution processing. On the other hand, the image distribution unit 11 may perform the distribution processing in case of receiving the state information from the monitoring state input unit 32.

Next, the operation of above-described distribution processing will be explained. As the distribution processing, there are a first distribution processing in which images to be distributed to observers are not determined in advance, and a second distribution processing in which images to be distributed to observers are determined in advance.

Firstly, the first distribution processing will be explained.

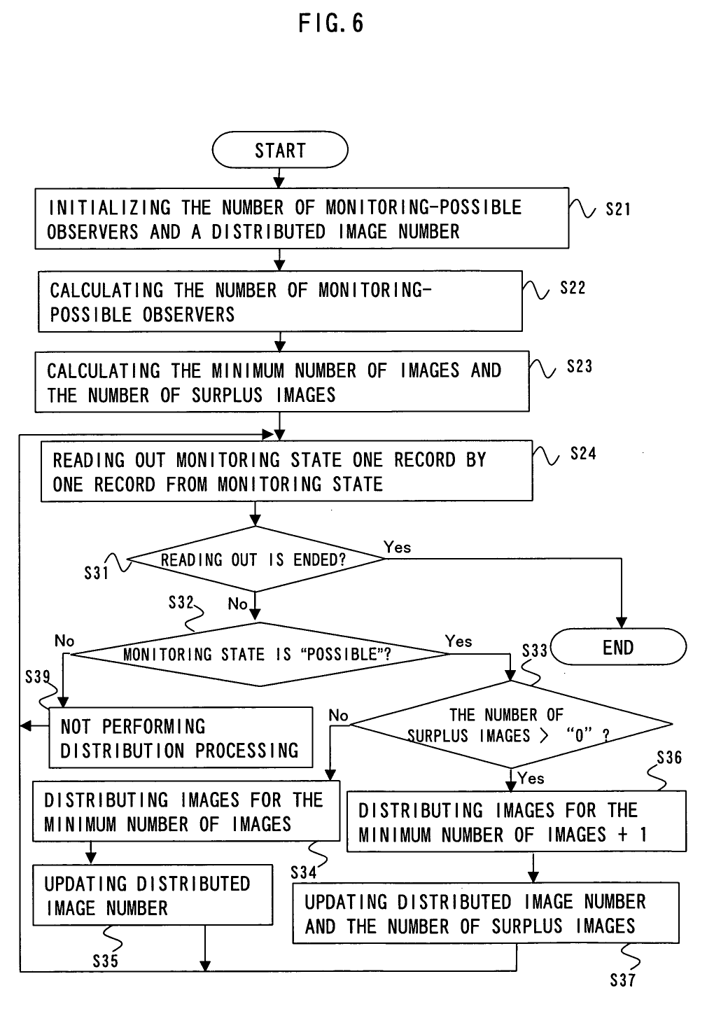

FIG. 6 shows a flowchart indicative of one example of the operation of the first distribution processing according to the embodiment. Firstly, the image distribution unit 11 initializes the number of monitoring-possible observers and a distributed image number (S21). The number of monitoring-possible observers is the number of observers whose monitoring state is “possible”, and is initialized to “0” in this processing. The distributed image number is an image number which was lastly distributed, and is initialized to “0” in this processing.

Next, the image distribution unit 11 calculates the number of monitoring-possible observers from the monitoring state list (S22). The image distribution unit 11 reads out the monitoring state one record by one record (one observer by one observer) from the monitoring state list, and increments the number of monitoring-possible observers in case the monitoring state is “possible”. Accordingly, at the time when the image distribution unit 11 reads out the monitoring state list entirely, the number of monitoring-possible observers is set up.

Next, the image distribution unit 11 performs a pre-processing before the distribution processing (S23). In performing the pre-processing before the distribution processing, the minimum number of images and the number of surplus images are calculated using the following mathematical formulas. The minimum number of images has its fractional part truncated to be an integer number.

The minimum number of images=(the number of images to be monitored)/(the number of monitoring-possible observers)

The number of surplus images=(the number of images to be monitored)−(the minimum number of images)×(the number of monitoring-possible observers)

Then, the image distribution unit 11 reads out the monitoring state one record by one record (one observer by one observer) from the monitoring state list (S24), and judges whether or not reading out the monitoring state is ended. In case the reading out is ended (S31, Yes), this flow is ended. In case the reading out is not ended (S31, No), the processing goes to the next step. In this processing, an observer who corresponds to a read out record is set to a subject observer.

Then, the image distribution unit 11 judges whether or not the monitoring state of a subject observer is “possible”. In case of “impossible” (S32, No), the distribution processing for the subject observer is not performed (S39), returning to the processing of S24. In case of “possible” (S32, Yes), the processing goes to the next step. Next, the image distribution unit 11 judges whether or not the number of surplus images is larger than “0”. In case of being “0” (S33, No), the processing goes to S34. In case of being larger than “0” (S33, Yes), the processing goes to S36.

In case the processing of S33 is No, the image distribution unit 11 performs the processing of distributing images to the subject observer (S34). In this processing, images whose image numbers are from (the distributed image number+1) to (the distributed image number+the minimum number of images) are distributed to the subject observer. Next, the image distribution unit 11 updates the distributed image number (S35), returning to the processing of S24. The distributed image number comes to be an image number which was lastly distributed (the distributed image number+the minimum number of images).

In case the processing of S33 is Yes, the image distribution unit 11 performs the processing of distributing images to the subject observer (S36). In this processing, images whose image numbers are from (the distributed image number+1) to (the distributed image number+the minimum number of images+1) are distributed to the subject observer. Next, the image distribution unit 11 updates the distributed image number and the number of surplus images (S37), returning to the processing of S24. The distributed image number comes to be an image number which was lastly distributed (the distributed image number+the minimum number of images+1), and the number of surplus images is decremented by “1”.

By performing the first distribution processing, it is unnecessary to determine images to be distributed to the respective observers in advance, and it becomes possible to evenly distribute images to the utmost extent.

Next, the second distribution processing will be explained.

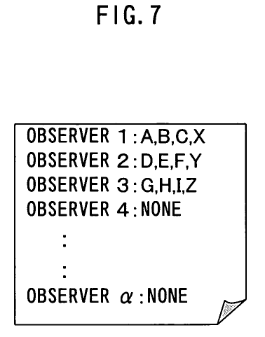

In this case, the observer information management unit 12 retains a standard monitoring image list which has been registered by the manager of the center system 101 in advance. Standard monitoring images are images which have been determined in advance, and are to be monitored by respective observers. Standard monitoring image numbers which are image numbers of the standard monitoring images are registered in the standard monitoring image list. FIG. 7 shows a table indicative of one example of the standard monitoring image list according to the embodiment. Similar to the delivery image list, the standard monitoring image list has registered therein image numbers which are determined in advance for respective observers.

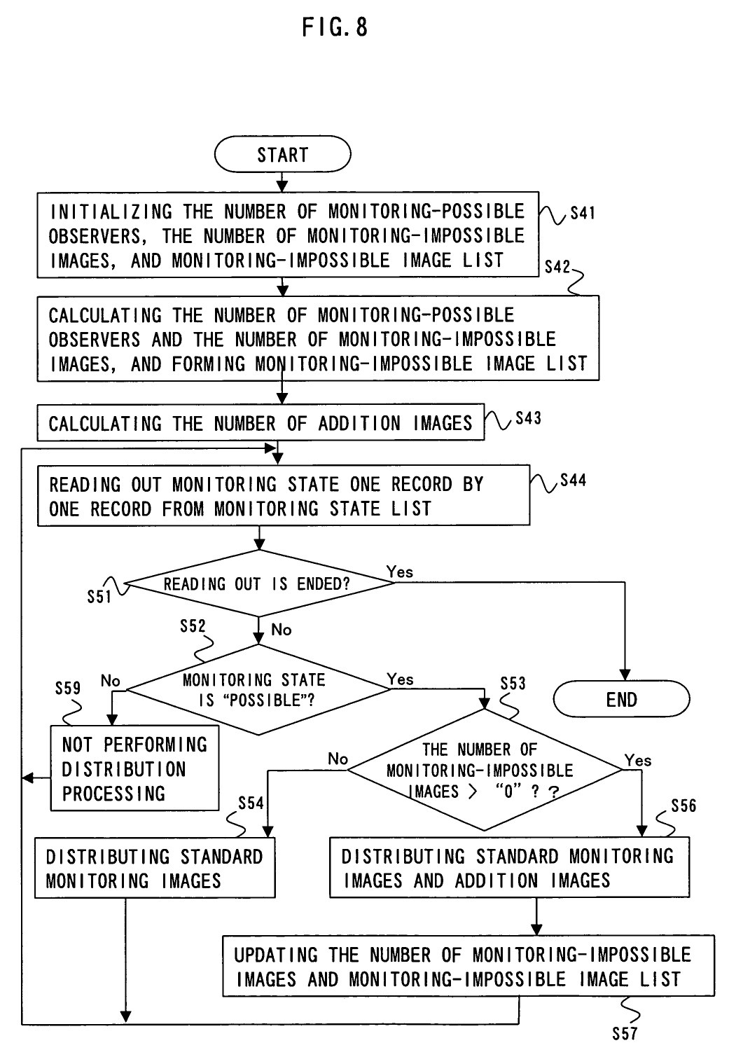

FIG. 8 shows a flowchart indicative of one example of the operation of the second distribution processing according to the embodiment. Firstly, the image distribution unit 11 initializes the number of monitoring-possible observers, the number of monitoring-impossible images, and a monitoring-impossible image list (S41). The number of monitoring-possible observers is initialized to “0”. The number of monitoring-impossible images is the number of images which cannot be monitored, and is initialized to “0” in this processing. The monitoring-impossible image list is a list of monitoring-impossible images, and is cleared in this processing. The monitoring-impossible images are the standard monitoring images corresponding to observers who cannot perform the monitoring work, and are distributed to observers who can perform the monitoring work.

Next, the image distribution unit 11 calculates the number of monitoring-possible observers and the number of monitoring-impossible images from the monitoring state list, and forms the monitoring-impossible image list (S42). The image distribution unit 11 reads out the monitoring state one record by one record (one observer by one observer) from the monitoring state list, and increments the number of monitoring-possible observers in case the monitoring state is “possible”. Accordingly, at the time when the image distribution unit 11 reads out the monitoring state list entirely, the number of monitoring-possible observers is set up. In case the monitoring state is “impossible”, the number of standard monitoring images of the observer is added to the number of monitoring-impossible images, and standard monitoring image numbers of the observer are added in the monitoring-impossible image list.

Next, the image distribution unit 11 performs a pre-processing before the distribution processing (S43). In performing the pre-processing before the distribution processing, the number of addition images is calculated using the following mathematical formula. The number of addition images has its fractional part truncated to be an integer number.

The number of addition images=(the number of monitoring-impossible images)/(the number of monitoring-possible observers)

Then, the image distribution unit 11 reads out the monitoring state one record by one record (one observer by one observer) from the monitoring state list (S44), and judges whether or not reading out the monitoring state list is ended. In case the reading out is ended (S51, Yes), this flow is ended. In case the reading out is not ended (S51, No), the processing goes to the next step. In this processing, an observer who corresponds to a read out record is set to a subject observer.

Then, the image distribution unit 11 judges whether or not the monitoring state of a subject observer is “possible”. In case of “impossible” (S52, No), the distribution processing for the subject observer is not performed (S59), returning to the processing of S44. In case of “possible” (S52, Yes), the processing goes to the next step. Next, the image distribution unit 11 judges whether or not the number of monitoring-impossible images is larger than “0” (S53).

In case the number of monitoring-impossible images is “0” (S53, No), the image distribution unit 11 performs the processing of distributing the standard monitoring images to the subject observer (S54), returning to the processing of S44. The image distribution unit 11 obtains image numbers of the subject observer in the standard monitoring image list, and registers the image numbers as image numbers of the subject observer in the delivery image list.

In case the number of monitoring-impossible images is larger than “0” (S53, Yes), the image distribution unit 11 performs the processing of distributing the standard monitoring images and the addition images to the subject observer (S56). The image distribution unit 11 obtains image numbers of the subject observer in the standard monitoring image list, and registers the image numbers as image numbers of the subject observer in the delivery image list. Further, the image distribution unit 11 obtains image numbers corresponding to the number of addition images from the monitoring-impossible image list, and registers the image numbers as image numbers of the subject observer in the delivery image list. Next, the image distribution unit 11 updates the number of monitoring-impossible images and the monitoring-impossible image list (S57), returning to the processing of S44. In this processing, the image distribution unit 11 decrements the number of monitoring-impossible images by the number of addition images, and deletes the addition images from the monitoring-impossible image list.

By performing the second distribution processing, it becomes possible to designate images to be monitored for the respective observers, and the observers can keep monitoring determined images.

Next, a specific example of the operation of the system for delivering images will be explained.

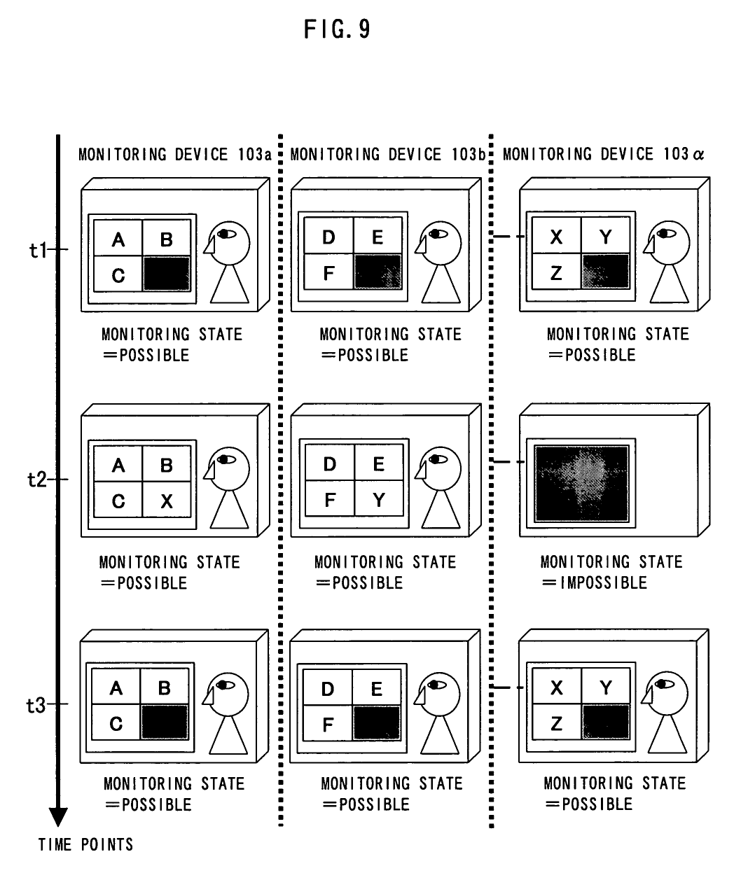

FIG. 9 shows a specific example of the operation of the system for delivering images according to the embodiment. In this drawing, an axis in the downward direction indicates time points. A plurality of monitoring devices 103a, 103b, 103 α which are arranged in the lateral direction at the respective time points represent the monitoring state of corresponding observers and delivered images.

Firstly, at time point “t1”, the monitoring state of observers corresponding to the monitoring devices 103a, 103b, 103α is “possible” respectively, and images A, B, C are delivered to the monitoring device 103a, images D, E, F are delivered to the monitoring device 103b, and images X, Y, Z are delivered to the monitoring device 103α. Next, at time point “t2”, in case the observer corresponding to the monitoring device 103α suspends the monitoring work (presses the button of the monitoring state input unit 32), the monitoring state of the observer corresponding to the monitoring device 103α becomes “impossible”. Accordingly, the images A, B, C, X are delivered to the monitoring device 103a, and the images D, E, F, Y are delivered to the monitoring device 103b. In this way, when the monitoring state of a monitoring device changes from “possible” to “impossible”, images which were delivered to the monitoring device come to be distributed to other monitoring devices, which makes it possible to keep monitoring the images. Next, at time point “t3”, in case the observer corresponding to the monitoring device 103α resumes the monitoring work (presses the button of the monitoring state input unit 32 again), the monitoring state of the observer corresponding to the monitoring device 103α becomes “possible”, and the images A, B, C are delivered to the monitoring device 103a, the images D, E, F are delivered to the monitoring device 103b, and the images X, Y, Z are delivered to the monitoring device 103α, as is similar to the case at time point “t1”. In this way, when the monitoring state of a monitoring device changes from “impossible” to “possible”, images are delivered to the monitoring device again, which can make the monitoring device resume monitoring the images.

According to the embodiment, images are distributed to be delivered according to the monitoring state of observers. Accordingly, it is not necessary to prepare observers for alternation with respect to one display unit, which makes it possible to dispersedly allocate observers geographically. Furthermore, it becomes possible to determine the number of observers which is suitable for the total number of images to be monitored, and it becomes unnecessary to allocate extra observers.

### Second Embodiment

In this embodiment, a system for delivering images will be explained, in which monitoring devices judge the state of observers.

Firstly, the configuration of the system for delivering images according to the second embodiment will be explained.

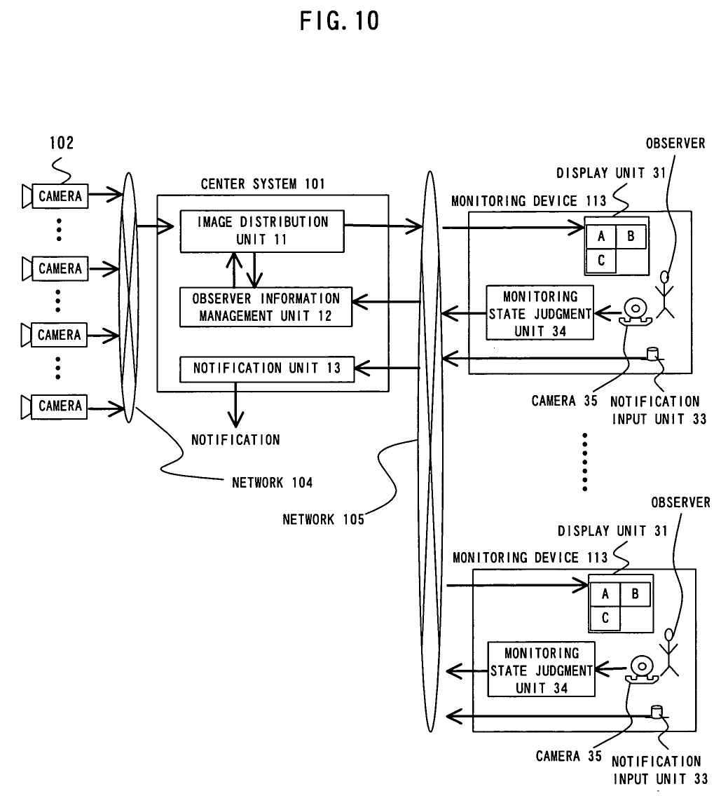

FIG. 10 shows a block diagram indicative of one example of the configuration of the system for delivering images according to the second embodiment. In this drawing, parts or components similar to those shown in FIG. 1 are indicated with the same reference numerals, and detailed explanation of which will be omitted. As shown in FIG. 10, when compared with FIG. 1, the system for delivering images includes monitoring devices 113 instead of the monitoring devices 103. Furthermore, when compared with the monitoring devices 103, each of the monitoring devices 113 includes a monitoring state judgment unit 34 and a camera 35 instead of the monitoring state input unit 32.

Next, the operation of the system for delivering images according to the embodiment will be explained.

Each of the cameras 35 is so arranged as to pick up the face of an observer squarely at the time of monitoring images, and outputs thus picked up images to the monitoring state judgment unit 34 as monitoring state images. The monitoring state judgment unit 34 performs the monitoring state judgment processing of judging the monitoring state of the observer based on the monitoring state images. On the other hand, other sensors may be used to detect the monitoring state of observers instead of the cameras 35.

Next, the monitoring state judgment processing will be explained.

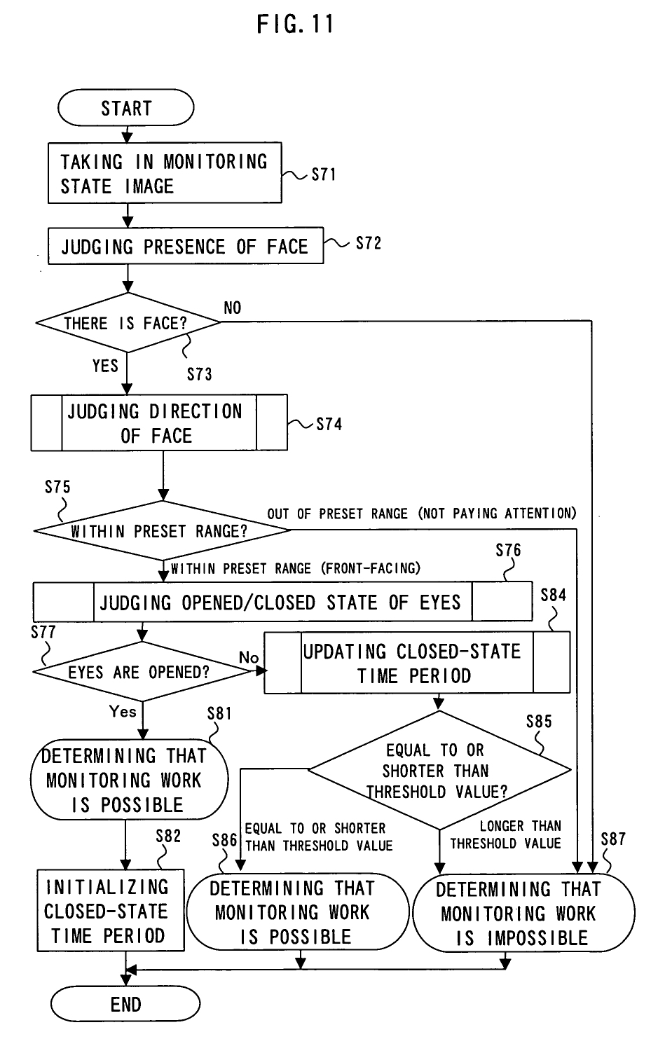

Firstly, a closed-state time period indicative of a time period during which an observer closes the eyelids is initialized. FIG. 11 shows a flowchart indicative of one example of the operation of the monitoring state judgment processing according to the embodiment. At first, the monitoring state judgment unit 34 takes in a monitoring state image from the camera 35 (S71). Then, the monitoring state judgment unit 34 judges whether or not the monitoring state image has a face picked up therein (S72). In case there is no face (S73, No), it is determined that the monitoring work is impossible (S87), ending the flow. In case there is a face (S73, Yes), the processing goes to the next step.

Next, the monitoring state judgment unit 34 judges the direction of the face in the monitoring state image (S74). In case the direction of the face is out of a preset range around the front-facing direction, that is, in case of not paying attention to images (S75, out of range), it is determined that the monitoring work is impossible (S87), ending the flow. In case the direction of the face is within a preset range around the front-facing direction (S75, within range), the processing goes to the next step. Then, the monitoring state judgment unit 34 judges the opened/closed state of eyes in the monitoring state image (S76), judging whether or not eyes are opened (S77).

In case eyes are opened (S77, Yes), the monitoring state judgment unit 34 determines that the monitoring work is possible (S81), and initializes the closed-state time period (S82), ending the flow.

In case eyes are closed (S77, No), the monitoring state judgment unit 34 updates the closed-state time period to set a time period from a time point when the closed-state time period is initialized to the current time point as a new closed-state time period (S84), and judges whether or not the new closed-state time period is equal to or shorter than a threshold value. In case the new closed-state time period is equal to or shorter than a threshold value (S85, equal to or shorter than a threshold value), it is determined that the monitoring work is possible (S86), ending the flow. On the other hand, in case the new closed-state time period is longer than a threshold value (S85, longer than a threshold value), it is determined that the monitoring work is impossible (S87), ending the flow. The threshold value is the upper limit of a closed-state time period which can be seen as a blink.

Next, the monitoring state judgment unit 34 sends the judgment result (monitoring work is possible or monitoring work is impossible) by the monitoring state judgment processing to the observer information management unit 12 as the state information. The observer information management unit 12 updates the monitoring state list in accordance with thus received state information.

Other operation of the system for delivering images according to the embodiment is similar to that in the first embodiment.

According to the embodiment, even if an observer does not press the button, the state in which the monitoring work is impossible due to the temporary absence of the observer can be determined. Furthermore, since the state in which the monitoring work is impossible due to the lack of concentration, etc., of the observer can be determined, failure in the monitoring work can be reduced. Accordingly, delay in finding out abnormal circumstances due to the failure in the monitoring work can be reduced.

### Third Embodiment

In this embodiment, a system for delivering images will be explained, in which the center system judges the state of observers.

Firstly, the configuration of the system for delivering images according to the third embodiment will be explained.

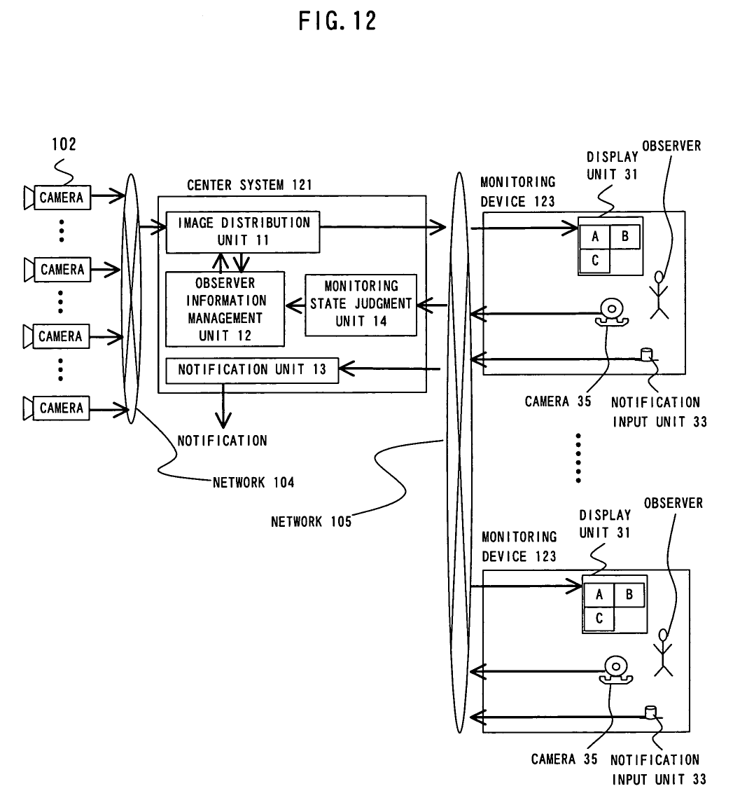

FIG. 12 shows a block diagram indicative of one example of the configuration of the system for delivering images according to the third embodiment. In this drawing, parts or components similar to those shown in FIG. 10 are indicated with the same reference numerals, and detailed explanation of which will be omitted. As shown in FIG. 12, when compared with FIG. 10, the system for delivering images includes a center system 121 instead of the center system 101, and monitoring devices 123 instead of the monitoring devices 113. Furthermore, when compared with the center system 101, the center system 121 further includes a monitoring state judgment unit 14. Moreover, when compared with the monitoring devices 113, each of the monitoring devices 123 does not require the monitoring state judgment unit 34.

Next, the operation of the system for delivering images according to the embodiment will be explained.

Each of the cameras 35 outputs picked up monitoring state images to the monitoring state judgment unit 14 as is similar to the second embodiment. The monitoring state judgment unit 14 performs the monitoring state judgment processing of judging the monitoring state of observers based on the monitoring state images. The monitoring state judgment processing is similar to that in the second embodiment.

According to the embodiment, since the monitoring state judgment processing is performed at the center system 121, the monitoring devices 123 can be realized at low cost.

On the other hand, an image receiving unit and a delivery unit correspond to the image distribution unit 11 in these embodiments. Furthermore, a state receiving unit and a standard information receiving unit correspond to the observer information management unit 12 in these embodiments. Moreover, a monitor and a display control unit correspond to the display unit 31 in these embodiments. Yet, moreover, a state detection unit corresponds to the monitoring state input unit 32 or the camera 35 in these embodiments. Yet, moreover, a state judgment unit corresponds to the monitoring state judgment unit 14 or the monitoring state judgment unit 34 in these embodiments. Yet, moreover, an image pickup unit corresponds to the camera 102 in these embodiments.

On the other hand, an image receiving step corresponds to the processing of S11 in these embodiments. Furthermore, a state receiving step corresponds to the processing of S24, S44 in these embodiments. Moreover, a delivery step corresponds to the processing of S31 to S37, S51 to S57 in these embodiments.

The center system in these embodiments can be easily applied to an information processing device, which can enhance the performance thereof. As the information processing device, a server etc. may be included. Furthermore, the monitoring device in these embodiments can be easily applied to an information processing device, which can enhance the performance thereof. As the information processing device, a PC (personal computer), workstation, PDA (personal digital assistant), etc., may be included.

Furthermore, a program that makes a computer configuring the center system execute above-described respective steps can be provided as a program for delivering images. Being stored in a computer-readable recording medium, the program can make a computer configuring the center system execute above-described respective steps. The computer-readable recording medium may be an internal storage to be mounted in a computer such as a ROM or RAM, or a portable recording medium such as a CD-ROM, flexible disk, DVD disk, magnet-optical disk, IC card, or a database storing computer programs, or other computers and their databases, or a transmission medium on a line.

What is claimed is:

1. A system for delivering images to at least one monitor, the system comprising:
an image receiving unit that takes in at least one image to be displayed on the monitor;
a state receiving unit that takes in the monitoring state of the respective monitors; and
a delivery unit that selects destination monitors from among the monitors based on the monitoring state taken in by the state receiving unit, and selects delivery images which are imaged to be delivered to the respective destination monitors from among images taken in by the image receiving unit, and delivers the delivery images to the corresponding destination monitors.

2. The system for delivering images according to claim 1,
wherein the delivery unit sets monitors whose monitoring state is normal to normal monitors, and sets the normal monitors to the destination monitors.

3. The system for delivering images according to claim 2,
wherein the delivery unit distributes images taken in by the image receiving unit to the destination monitors, and updates the distribution result as delivery images for the respective destination monitors.

4. The system for delivering images according to claim 2,
wherein the image receiving unit further takes in pickup source identifiers indicative of pickup sources of taken in images,
the system further comprising:
a standard information receiving unit that, with respect to standard images which are images to be displayed on the monitors, takes in pickup source identifiers of the standard images for the respective monitors set up in advance;
wherein the delivery unit sets monitors other than the normal monitors to abnormal monitors, and, based on pickup source identifiers taken in by the image receiving unit and pickup source identifiers taken in by the standard information receiving unit, sets standard images corresponding to the normal monitors to delivery images to the normal monitors, and delivers standard images corresponding to the abnormal monitors to the normal monitors.

5. The system for delivering images according to claim 1,
wherein, in case a plurality of delivery images are selected for a specific destination monitor, the delivery unit combines the plural delivery images to set thus combined image to a delivery image, and delivers the delivery image to the specific destination monitor.

6. The system for delivering images according to claim 1,
wherein, in case a plurality of delivery images are selected for a specific destination monitor, the delivery unit delivers the plural delivery images and delivery information which is information related to the delivery images to the specific destination monitor,
the system further comprising:
display control units each of which receives a plurality of delivery images and delivery information delivered from the delivery unit, and combines the plural delivery images based on the delivery information to set thus combined image to a single display image, and makes the specific destination monitor display the display image.

7. The system for delivering images according to claim 6,
wherein the delivery information includes the number of the plural delivery images to be delivered to the specific destination monitor.

8. The system for delivering images according to claim 6,
wherein, with respect to the plural delivery images to be delivered to the specific destination monitor, the delivery information includes disposition information at the time of displaying the delivery images.

9. The system for delivering images according to claim 1, further comprising:
state detection units which are arranged for the respective monitors, each of which detects the monitoring state of the monitor to output thus detected monitoring state to the state receiving unit.

10. The system for delivering images according to claim 9,
wherein the state detection units output inputs from the observers for the monitors to the state receiving unit as the monitoring state.

11. The system for delivering images according to claim 9,
wherein the state detection units detect the environment of the monitors to output the detection result,
the system further comprising:
state judgment units each of which judges whether or not the observer normally monitors the monitor based on the detection result by the state detection unit, and outputs the judgment result to the state receiving unit as the monitoring state.

12. The system for delivering images according to claim 11,
wherein the state detection units pick up images, and are so arranged as to pick up observers who monitor the monitors to send the picking up result to the state judgment units as the detection result.

13. The system for delivering images according to claim 12,
wherein each of the state judgment units extracts, from the picking up result by the state detection unit, at least any one of the presence of the observer, direction of the face of the observer, time period during which eyes of the observer are closed, and determines that the monitoring state is normal in case the extraction result fulfills a predetermined condition.

14. The system for delivering images according to claim 1, further comprising:
image pickup units which pick up subjects to be monitored, and output thus picked up images to the image receiving unit.

15. The system for delivering images according to claim 1, further comprising:
notification input units which are arranged for the respective monitors, and receive input of notification by the observers for the monitors.

16. The system for delivering images according to claim 1,
wherein the delivery unit selects the destination monitors and the delivery images every time the monitoring state is changed.

17. A computer-readable recording medium which stores a program for delivering images which makes a computer deliver images to be displayed on monitors, the program comprising:
an image receiving step that takes in at least one image to be displayed on the monitors;
a state receiving step that takes in the monitoring state of the respective monitors; and
a delivery step that selects destination monitors from among the monitors based on the monitoring state taken in by the state receiving step, and selects delivery images which are images to be delivered to the respective destination monitors from among images taken in by the image receiving step, and delivers the delivery images to the corresponding destination monitors.

18. The computer-readable recording medium which stores the program for delivering images according to claim 17,
wherein the delivery step sets monitors whose monitoring state is normal to normal monitors, and sets the normal monitors to the destination monitors.

19. The computer-readable recording medium which stores the program for delivering images according to claim 18,
wherein the delivery step distributes images taken in by the image receiving step to the destination monitors, and sets the distribution result to delivery images for the respective destination monitors.

20. A method for delivering images to be displayed on monitors, the method comprising:
an image receiving step that takes in at least one image to be displayed on the monitors;
a state receiving step that takes in the monitoring state of the respective monitors; and
a delivery step that selects destination monitors from among the monitors based on the monitoring state taken in by the state receiving step, and selects delivery images which are images to be delivered to the respective destination monitors from among images taken in by the image receiving step, and delivers the delivery images to the corresponding destination monitors.
